(19) United States
(12) Patent Application Publication
(10) Pub. No.: US 2018/0036742 A1
(43) Pub. Date: Feb. 8, 2018

(54) Mining Collector Compositions Containing Dodecylmethyl Sulfide and Processes for the Recovery of Metals Therewith

(71) Applicant: Chevron Phillips Chemical Company LP, The Woodlands, TX (US)

(72) Inventors: Jim D. Byers, Bartlesville, OK (US); Jason L. Kreider, Copan, OK (US); Kenneth M. Lassen, Bartlesville, OK (US)

(21) Appl. No.: 15/227,994

(22) Filed: Aug. 4, 2016

(51) Int. Cl. B03D 1/012

(52) U.S. Cl. CPC B03D 1/012; B03D 2203/025; B03D 2201/007; B03D 2201/04; B03D 2201/02

(57) ABSTRACT

The present invention discloses water-based mining collector compositions containing dodecylmethyl sulfide. Floatation processes for recovering metals, such as copper and molybdenum, from ores using the mining chemical collector compositions also are disclosed.

### BACKGROUND OF THE INVENTION

The present invention relates generally to water-based mining collector compositions containing dodecylmethyl sulfide. These collector compositions can be used in flotation processes for recovering metals, such as copper and molybdenum, from ores.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Various mining chemical collector compositions and collector agents are disclosed herein. In one aspect, a collector composition of this invention can comprise dodecylmethyl sulfide and water, while in another aspect, a collector composition can comprise dodecylmethyl sulfide and a pH control agent, and in yet another aspect, a collector composition can comprise dodecylmethyl sulfide and a frothing agent. Accordingly, a particular collector composition of this invention can comprise dodecylmethyl sulfide, a frothing agent, a pH control agent, and water.

Flotation processes for the recovery of a metal (or metals) from an ore also are disclosed herein. These processes can comprise contacting the ore with any of the collector compositions containing dodecylmethyl sulfide disclosed herein. The metal can comprise any suitable transition metal, such as copper, molybdenum, iron, and the like, as well as combinations of two or more metals. Unexpectedly, the collector compositions disclosed herein can have advantageous metal recovery rates compared to other mining collector systems.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter can be described such that, within particular aspects, a combination of different features can be envisioned. For each and every aspect and/or feature disclosed herein, all combinations that do not detrimentally affect the designs, compositions, processes, and/or methods described herein are contemplated with or without explicit description of the particular combination. Additionally, unless explicitly recited otherwise, any aspect and/or feature disclosed herein can be combined to describe inventive features consistent with the present disclosure.

While compositions and methods are described herein in terms of “comprising” various components or steps, the compositions and methods can also “consist essentially of” or “consist of” the various components or steps, unless stated otherwise. For example, a collector composition consistent with aspects of the present invention can comprise; alternatively, can consist essentially of; or alternatively, can consist of; dodecylmethyl sulfide, a pH control agent, a frothing agent, and water.

The terms “a,” “an,” and “the” are intended to include plural alternatives, e.g., at least one. For instance, the disclosure of “a frothing agent,” “a transition metal,” etc., is meant to encompass one, or mixtures or combinations of more than one, frothing agent, transition metal, etc., unless otherwise specified.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

For any particular compound or group disclosed herein, any name or structure presented is intended to encompass all structural isomers, conformational isomers, regioisomers, stereoisomers, and mixtures thereof that can arise from a particular set of substituents, unless otherwise specified. The name or structure also encompasses all enantiomers, diastereomers, and other optical isomers (if there are any), whether in enantiomeric or racemic forms, as well as mixtures of stereoisomers, as would be recognized by a skilled artisan, unless otherwise specified. For example, a general reference to hexene (or hexenes) includes all linear or branched, acyclic or cyclic, hydrocarbon compounds having six carbon atoms and 1 carbon-carbon double bond; pentane includes n-pentane, 2-methyl-butane, and 2,2-dimethylpropane; and a general reference to a butyl group includes an n-butyl group, a sec-butyl group, an iso-butyl group, and a t-butyl group.

In one aspect, a chemical “group” can be defined or described according to how that group is formally derived from a reference or “parent” compound, for example, by the number of hydrogen atoms removed from the parent compound to generate the group, even if that group is not literally synthesized in such a manner. These groups can be utilized as substituents, can be coordinated or bonded to metal atoms, or can be substituted or unsubstituted. By way of example, an “alkyl group” formally can be derived by removing a hydrogen atom (one or more, as necessary for the particular group) from a carbon atom of an alkane. The disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedures, unless specified otherwise or the context requires otherwise.

The terms “contact product,” “contacting,” and the like, are used herein to describe compositions and methods wherein the components are contacted together in any order, in any manner, and for any length of time, unless otherwise specified. For example, the components can be contacted by blending or mixing. Further, unless otherwise specified, the contacting of any component can occur in the presence or absence of any other component of the compositions and methods described herein. Combining additional materials or components can be done by any suitable method. Further, the term “contact product” includes mixtures, blends, solutions, slurries, reaction products, and the like, or combinations thereof. Although “contact product” can, and often does, include reaction products, it is not required for the respective components to react with one another. Similarly, the term “contacting” is used herein to refer to materials which can be blended, mixed, slurried, dissolved, reacted, treated, or otherwise contacted in some other manner. Therefore, the term “contacting” encompasses the “reacting” of two or more components, and it also encompasses the “mixing” or “blending” of two or more components that do not react with one another.

Although any methods and materials similar or equivalent to those described herein can be used in the practice or testing of the invention, the typical methods and materials are herein described.

All publications and patents mentioned herein are incorporated herein by reference for the purpose of describing and disclosing, for example, the constructs and methodologies that are described in the publications, which might be used in connection with the presently described invention.

### DETAILED DESCRIPTION OF THE INVENTION

The present invention provides mining chemical collector compositions containing dodecylmethyl sulfide, and often such mining chemical collector compositions can contain dodecylmethyl sulfide, a pH control agent, a frothing agent, and water. While not wishing to be bound by the following theory, a benefit of these collector compositions—which contain dodecylmethyl sulfide—can be higher recovery rates of desirable metals from various metal-bearing ores. Another benefit of these collector compositions can be a lower recovery rate of undesirable metals from various metal-bearing ores. Unexpectedly, it was found that the collector compositions disclosed herein provide very high recovery of desirable metals (such as copper), yet provide very low recovery of undesirable metals (such as iron), from various metal-bearing ores, including chalcopyrite, chalcocite, and the like.

### Mining Chemical Collector Compositions

Aspects of this invention are directed to collector compositions (e.g., mining chemical collector compositions) comprising dodecylmethyl sulfide. Unexpectedly, it was found that the collector compositions disclosed herein are very effective at removing certain desirable minerals from mining ores. Further, the collector compositions disclosed herein were also found to be very selective with regard to minimizing the recovery of undesirable metals from the mining ores.

In one aspect, a collector composition of this invention can comprise dodecylmethyl sulfide and water. Often, the amount of water in the collector composition can be greater than about 75 wt. %, greater than about 95 wt. %, or greater than about 99 wt. %, and typical non-limiting ranges include from about 75 to about 99.99 wt. %, from about 95 to about 99.99 wt. %, or from about 99 to about 99.99 wt. % water, based on the total weight of the collector composition.

In another aspect, the collector composition of this invention can comprise dodecylmethyl sulfide and a suitable pH control agent. Illustrative pH control agents can include, but are not limited to, lime, carbonate compounds, and the like, as well as combinations thereof. In yet another aspect, the collector composition can comprise dodecylmethyl sulfide and a suitable frothing agent. Illustrative frothing agents can include, but are not limited to, pine oil; alcohols such as methyl isobutyl carbinol (MIBC); and polyether alcohols such as NALFLOTE® 9837 and Cytec OREPREP® X-133. Combinations of more than one frothing agent can be used. In still another aspect, the collector composition can comprise dodecylmethyl sulfide, a frothing agent, a pH control agent, and water. The amount of dodecylmethyl sulfide present in the collector composition (excluding the weight of water) typically can be less than about 0.1 wt. %, less than about 0.01 wt. %, less than about 0.001 wt. %, or less than about 0.0001 wt. %.

Collector compositions consistent with this invention can comprise dodecylmethyl sulfide and can contain other components—such as other suitable collector agents, frothing agents, pH control agents, and water, amongst others—and these compositions can be contacted with an ore, as described further hereinbelow. Any suitable order of contacting any components of the collector composition with the ore can be used; and such collector compositions, whether solutions, slurries, blends, immiscible mixtures (e.g., dodecylmethyl sulfide is not soluble/miscible in water), and so forth, are encompassed herein. For instance, a ground ore can be contacted with, in any order, dodecylmethyl sulfide, a frothing agent, a pH control agent, and a first amount of water (which can be relatively small), resulting in a slurry of the ore and a collector composition comprising dodecylmethyl sulfide, the frothing agent, the pH control agent, and water. In some aspects, a second amount of water (which can be relatively large) can be added to this slurry prior to the flotation process, resulting in a slurry of the ore in a collector composition comprising lower concentrations of dodecylmethyl sulfide, the frothing agent, and the pH control agent. Other suitable methods and orders of forming the collector compositions, whether in the presence of the ore or not, would be readily recognized by those of skill in the art, and such are encompassed herein.

Moreover, dodecylmethyl sulfide can be used alone or in combination with other suitable (second) collector agents, if desired. Thus, any of the collector compositions can further comprise a second collector agent, non-limiting examples of which can include a xanthate, a xanthic ester, a thionocarbonate, a dialkyl dithiophosphate, and the like, as well as combinations thereof.

In aspects of the invention wherein a second collector agent is present, the collector composition can comprise dodecylmethyl sulfide and the second collector agent, wherein the weight ratio of dodecylmethyl sulfide to the second collector agent can be in a range from about 1:10 to about 10:1, from about 1:5 to about 5:1, from about 1:3 to about 1:1, from about 1:2 to about 2:1, from about 1:1 to about 1:10, or from about 10:1 to about 1:1. Additionally, in some aspects, the collector composition can comprise from about 10 wt. % to about 90 wt. % dodecylmethyl sulfide and from about 10 wt. % to about 90 wt. % of a second collector agent, based on the total weight of collector agents.

### Flotation Processes

Also provided herein are flotation processes for the recovery of metals from ores. The metal can be recovered in any form, for instance, a metal-containing mineral or compound (e.g., copper sulfides, molybdenum sulfides), a metal ion, or elemental metal, as well as combinations thereof. One such flotation process for the recovery of a metal from an ore can comprise contacting the ore with any of the collector compositions disclosed herein. Equipment and techniques for the flotation recovery of various metals from mining ores are well known to those of skill in the art, and are illustrated representatively herein in the examples that follow.

Generally, the metal recovered from the ore comprises a transition metal, one or more Group 3-12 metals. In some aspects, the metal can comprise a Group 3-11 transition metal, or a Group 5-12 transition metal, while in other aspects, the metal can comprise gold, silver, platinum, copper, nickel, iron, lead, zinc, molybdenum, cobalt, or chromium, as well as combinations thereof. In particular aspects of this invention, the metal can comprise copper and molybdenum; alternatively, copper; or alternatively, molybdenum. In addition, other transition metals, such as iron, can be recovered along with copper and/or molybdenum.

The flotation processes and mining chemical collector compositions described herein are not limited to any particular ore. However, the effectiveness of such processes and compositions are particularly beneficial when the ore comprises a copper-bearing ore, a molybdenum-bearing ore, an iron-bearing ore, or ores that are any combination of copper-bearing, molybdenum-bearing, and iron-bearing (e.g., a copper-bearing and molybdenum-bearing ore). Illustrative and non-limiting examples of such ores include chalcopyrite, chalcocite, pyrite, and the like.

Any suitable amount of the collector composition and/or dodecylmethyl sulfide can be used in the flotation recovery processes. Often, but not limited thereto, the collector composition (excluding the weight of water in the collector composition) and the ore are contacted at a weight ratio in a range from about 1 g of the collector composition per ton of ore to about 5 kg of the collector composition per ton of ore, or from about 10 g of the collector composition per ton of ore to about 1 kg of the collector composition per ton of ore.

Similarly, any suitable amount of the collector agents (e.g., dodecylmethyl sulfide, dodecylmethyl sulfide and a second collector, etc.) can be used in the flotation recovery process. In certain aspects, the collector agents of the collector composition are contacted with the ore at a weight ratio in a range from about 1 g of collector agents per ton of ore to about 1 kg of the collector agents per ton of ore, or from about 1 g of collector agents to about 0.1 kg of collector agents per ton of ore.

Unexpectedly, collector compositions containing dodecylmethyl sulfide have high recovery rates of certain transition metals. For example, the percent recovery of copper in the flotation process can be at least about 70 wt. %, at least about 75 wt. %, at least about 80 wt. %, at least about 85 wt. %, at least about 90 wt. %, or at least about 92 wt. %. Similarly, the percent recovery of molybdenum in the flotation process can be at least about 60 wt. %, at least about 70 wt. %, at least about 75 wt. %, at least about 80 wt. %, at least about 85 wt. %, at least about 90 wt. %, or at least about 92 wt. %. Additionally, in certain aspects, the percent recovery of iron in the flotation process can be less than about 50 wt. %, less than about 40 wt. %, less than about 30 wt. %, less than about 25 wt. %, less than about 20 wt. %, less than about 15 wt. %, or less than about 10 wt. %. Percent (%) recovery is defined as the total amount of metal recovered after the flotation process compared to the total amount of metal present in the ore prior to the flotation process.

Furthermore and surprisingly, in some aspects, the percent recovery of copper, the percent recovery of molybdenum, or the percent recovery of copper and molybdenum, can be greater than that of a mine standard, under the same flotation conditions. As would be recognized by those of skill in the art, a mine standard is the prevailing collector composition currently being used for a given ore and/or desired transition metal. Mine standards are discussed in greater detail in the examples that follow. In some aspects, the percent recovery of copper, the percent recovery of molybdenum, or the percent recovery of copper and molybdenum, can be within about 5 wt. %, within about 3 wt. %, within about 2 wt. %, or within about 1 wt. %, of the mine standard, under the same flotation conditions. Moreover, and beneficially, the percent recovery of iron can be less than a mine standard by at least about 30 wt. %, at least about 25 wt. %, at least about 20 wt. %, at least about 10 wt. %, at least about 5 wt. %, at least about 3 wt. %, or at least about 2 wt. %, under the same flotation conditions.

Further still, and unexpectedly, in certain aspects of the invention, the percent recovery of copper can be greater than that of a collector composition comprising ethyl n-octyl sulfide, under the same flotation conditions. In some aspects, the percent recovery of copper can be at least about 15 wt. % greater, at least about 10 wt. % greater, at least about 5 wt. % greater, or at least about 3 wt. % greater, than the percent recovery of copper using a collector composition comprising ethyl n-octyl sulfide, or within about 5 wt. %, or within about 2 wt. %, of the percent recovery of copper using a collector composition comprising ethyl n-octyl sulfide, under the same flotation conditions. Likewise, in certain aspects, the percent recovery of molybdenum can be greater than that of a collector composition comprising ethyl n-octyl sulfide, under the same flotation conditions. In some aspects, the percent recovery of molybdenum can be at least about 3 wt. % greater, at least about 2 wt. % greater, or at least about 1 wt. % greater, than the percent recovery of molybdenum using a collector composition comprising ethyl n-octyl sulfide, or within about 5 wt. %, or within about 2 wt. %, of the percent recovery of molybdenum using a collector composition comprising ethyl n-octyl sulfide, under the same flotation conditions.

Advantageously, in certain aspects, the percent recovery of iron can be less than that of a collector composition comprising ethyl n-octyl sulfide, under the same flotation conditions. For instance, the percent recovery of iron can be at least about 5 wt. % less, at least about 3 wt. % less, or at least about 2 wt. % less, than the recovery of iron using a collector composition comprising ethyl n-octyl sulfide, or within about 5 wt. %, or within about 2 wt. %, of the recovery of iron using a collector composition comprising ethyl n-octyl sulfide, under the same flotation conditions.

### EXAMPLES

The invention is further illustrated by the following examples, which are not to be construed in any way as imposing limitations to the scope of this invention. Various other aspects, modifications, and equivalents thereof which, after reading the description herein, may suggest themselves to one of ordinary skill in the art without departing from the spirit of the present invention or the scope of the appended claims.

Samples were analyzed for molybdenum content by digesting an ore sample over heat in a solution containing potassium chlorate, nitric acid, and hydrochloric acid. After the digested sample was cooled, super floc clarifier was added, and the sample was analyzed via atomic absorption using a nitrous oxide-acetylene red flame. Standards ranged from 50-100 ppm by weight molybdenum. A similar procedure with the necessary modifications was used to analyze for copper content and iron content.

### Examples 1-16

### Flotation Recovery of Mining Chemicals

The procedures for the evaluation of different ores and the flotation recovery of various metals are different, but each generally starts with a grind size determination to determine the desired grind time to give a sample with the correct particle size distribution according to the US Standard mesh scale. An appropriate amount of ore from the appropriate mine (900 to 1000 grams, depending on the ore) was provided at the −10 mesh size. This ore was placed in a rod mill with 20 lb of rods with prescribed sizes, and an appropriate amount of water was added to give the desired solids content. The rod mill was turned on for the desired amount of time. This time was based on prior knowledge of that ore sample or an educated guess based on experience of similar ore materials. After grinding for the desired amount of time, the sample was poured and rinsed with a minimum amount of tap water into a container. The water and solids were poured through a 230 mesh wet screen sieve shaker while washing with water to remove any fines. This was done in two batches to facilitate the washing procedure. Failure to remove the fines often can result in the material being glued together in chunks, analogous to concrete. The remaining solids were removed from the screen with washing onto filter paper in a Buchner funnel with vacuum. The solids collected were dried in an oven overnight at 75° C. The dried solids were then screened through a series of screens (25 mesh, 40, 50, 70, 100, 140, 200, 230, and Pan) on a Ro-Tap® shaker in two batches, six minutes each. A total of three or more grind experiments were required to bracket the desired grind time and give a graph of time vs. wt. % dry solids on a certain mesh screen size.

For example, the grind size was 30 wt. %+100 mesh solids (meaning 30% of the particles are 149 microns or larger) for Ore 1, 20 wt. %+100 mesh solids (meaning 20% of the particles are 149 microns or larger) for Ore 2, and 36 wt. %+100 mesh solids (meaning 36% of the particles are 149 microns or larger) for Ore 3. The +100 includes everything collected on the 100 screen and larger (such as 25, 40, etc.). From the linear plot of this data, the ideal grind time was determined by adding the amount of solids on the screens up to the desired mesh size. From the plot of this data, the desired grind time was determined. This procedure can be done periodically, but is necessary if the ore type or the rod charge changes.

The compositions of each ore evaluated herein are summarized in Table I. Values are shown in wt. % for copper, iron, molybdenum, sulfur, and total insolubles.

The standard flotation procedure for Ore 1 (containing chalcopyrite) is as follows. A 1-kg charge of Ore 1 was added to a rod mill along with 650 mL tap water and approximately 1 g of lime (this amount can be adjusted to obtain the desired alkalinity, see below). The flotation collector reagents were added to the pool of water (not directly on the solids) in the mill using micro syringes: PAX (potassium amyl xanthate), 0.01 lb/ton @ 1% solution (1000 μL), made fresh daily; medium cycle oil (MCO), 0.05 lb/ton, 24.6 μL; MC 37 collector (mixture of tertiary dodecyl mercaptan and MCO), 0.05 lb/ton (26.1 μL); and plant frother (80% Nalco NALFLOTE® 9837/20% Cytec OREPREP® X-133), 28 μL. The mill was placed on rubber rollers and ground for the predetermined time. The mill was removed from the rollers and the solids washed into a transparent plastic flotation cell (2.5 L). Only enough water was used to reach the flotation volume (2-liter mark on flotation cell). If too little water was used to wash the material into the flotation cell, additional lime water was added to reach the 2-liter flotation volume. The solids amount was about 32 wt. % for Ore 1. The material was conditioned for two min at 1200 rpm, then floated for five min at 1200 rpm. Air was bubbled into solution at the rate of 8 L/min. Froth was removed from the surface of the cell approximately every 10 sec with a plastic paddle. The froth was collected in a glass pan under the lip of the cell. Liquid was added periodically to keep the solution near the lip of the cell so froth could be easily removed. Care was taken to not have froth flow over the lip without raking with the paddle. The standpipe and back cell corners were washed down as needed with lime water. Depending on the frothiness of the ore, it may be necessary to restrict the air at the beginning of the flotation to prevent froth from overflowing the cell on its own. Generally, the air valve was completely open by the end of the first minute. If not, then the amount of frother was adjusted. If it was difficult to maintain complete surface coverage with froth, a few more microliters of frothing agent were added. To do this, the air and timer were shut off, the froth concentrate added and conditioned for 30 sec before turning back on the air and timer.

The air and stirring were turned off and the apparatus washed to remove solids from the stirrer and shaft into the flotation cell. After allowing the solids to settle for a few minutes, a sample was taken for titration to determine alkalinity. The remaining tails were filtered through an 8 inch stainless steel filter (3 gal) onto shark skin filter paper. The collected solids were dried in an oven at 85° C. overnight to give dry solids that were weighed and labeled as tailings.

The rougher froth concentrate collected in the pan was filtered by washing onto filter paper and dried in an oven at 85° C. overnight. Temperature was kept at/below 85° C. to prevent oxidation and weight changes from occurring. The dried solids were weighed and labeled as concentrate. Both the tailings and concentrate were analyzed for determination of copper, molybdenum, and iron.

The alkalinity titration procedure defined an alkalinity of 1.0 as being equivalent to 0.01 lb of CaO per ton of solution. To prepare lime water of 30 alkalinity, 19 g of CaO were added to 50 L of water, agitated for at least one hour, then solids were settled overnight. The lime water was decanted for use. For titration, to a 50 mL alkaline solution, one drop of phenolphthalein indicator solution was added, and titrated with 0.02N H₂SO₄ solution until the pink color disappeared. Each mL of titrating solution equaled 2.0 alkalinity units.

Assuming a solution is 30 alkalinity, that is, 0.3 lb CaO per ton of solution, then, (0.3 lb CaO/ton solution)*(ton/2000 lb)*(8.345 lb/gal)*(gal/3.785 L)*(453.6 g/lb) converts to 0.15 g CaO/L, or 0.0075 g CaO/50 mL.

Since the molecular weight of CaO=56 g/mol, and the molecular weight of H₂SO₄=98 g/mol, and N=(Molarity)*(net positive charge), then

0.02N H₂SO₄=(0.02/2)*(98 g/mol)=(0.98 g/L)*(1 L/1000 mL)=0.00098 g/mL.

According to the stoichiometry of the reaction:

CaO+H₂SO₄=CaSO₄+H₂O,

then 98 g H₂SO₄ neutralizes 56 g CaO.

When 0.0075 g CaO are present, then 0.0075×98/56=0.013125 gm H₂SO₄ are required,

and 0.013125 g H₂SO₄/0.00098 g/mL=13.393 mL H₂SO₄.

The standard flotation procedure for Ore 2 is as follows. The grind size was determined as described herein above for Ore 1, except the desired grind for Ore 2 was 20% plus 100 mesh (meaning 20% of the particles are 149 microns or larger). The optimum grind time to achieve these results was 13.75 min. A 1-kg charge of ore was utilized. The amount of lime added to the grind was 1.2 g along with 500 μL of the PAX/dithiophosphate (DTP) 238 solution. The PAX/DTP 238 solution was prepared by mixing 153 mL of distilled water with 0.5 mL DTP 238 and 0.5 gram of PAX. The pH of the slurry was 10.5 after diluting with 650 mL of water and transferring to the flotation cell and diluting with water up to the 2-L mark. The slurry was stirred without air and 2000 μL of PAX/DTP 238 solution were added along with 34 μL of a 50/50 vol. mixture of pine oil/MIBC. The pulp was stirred at 1200 rpm for one min and then the 8 L/min air was turned on. The froth was then raked over the weir for 3 min into a pan. The air was turned off and an additional 34 μL of pine oil/MIBC (frother) and 2000 μL of PAX/DTP were added followed by conditioning for 1 min. The air was then turned back on and the froth collected for an additional 3 min into the pan. The air was then turned off while adding another 34 μL of pine oil/MIBC and 2000 μL of PAX/DTP followed by conditioning for 1 min while stirring. The air was then turned on for another min, followed by collecting the froth for 3 min. The air and stirring were then turned off and the concentrate pan was removed and the pulp mixture vacuum filtered to give the concentrate that was then dried in an oven overnight at 85° C. The tailings mixture was then poured out into a filter with filter paper to obtain a wet tailings mixture. This mixture was dried in an oven overnight at 85° C. The weight of the concentrate and tailings were recorded before analytical analysis.

The standard flotation procedure for Ore 3 is as follows. The grind size was determined as described herein above for Ore 1. The optimum grind time was 5 min 7 sec. A 900-g charge of ore, 0.6 g of lime, 32.5 μL of diesel, and 600 mL of water were charged into the rod mill. The optimum grind time was utilized and the material transferred to the flotation cell as described above in the Ore 1 procedure. Then, 1091 μL of a 1% solution of sodium ethyl xanthate and 28 μL of the 80/20 frother mentioned in the Ore 1 procedure were charged to the stirring liquid and conditioned for 1 min. The froth was collected for 3 min into a collection pan. The air was stopped and another 28 μL of frother and 546 μL of 1% sodium ethyl xanthate were added to the slurry. The air was restarted and a 1-min conditioning phase was performed. The froth was then collected for another 2 min into the collection. The concentrate and tailings material were filtered, dried and weighed as described for the Ore 1 process.

Tables II-IV summarize Examples 1-16, and the respective percent recoveries of copper, molybdenum, and iron from Ores 1-3. Duplicates of each flotation experiment were conducted, and the average was reported. Various collectors were employed including dodecylmethyl sulfide and ethyl n-octyl sulfide, and compared to mining collector standards.

The standard for Ore 1 (Example 1) was a collector composition (per ton basis) containing 1200 g of lime, 1000 μL of 1% potassium amyl xanthate (PAX), 25 μL of medium cycle oil (MCO), 26 μL of MC 37 (mixture of TDDM and MCO), and 28 μL of plant frother 80% Nalco NALFLOTE® 9837/20% Cytec OREPREP® X-133. Examples 2-6 for Ore 1 used a collector composition containing 1200 g of lime, the listed amount of the collector agent in Table II, and 28 μL of plant frother 80% Nalco NALFLOTE® 9837/20% Cytec OREPREP® X-133.

The standard for the Ore 2 (Example 7) was a collector composition (per ton basis) containing 1100 g of lime, 6500 μL of 1% PAX/DTP 238, and 102 μL of pine oil/MIBC (frother). Examples 8-10 for the Ore 2 used a collector composition containing 1100 g of lime, the listed amount of the collector agent in Table III, and 102 μL of pine oil/MIBC (frother).

The standard for Ore 3 (Example 11) was a collector composition (per ton basis) containing 600 g of lime, 1637 μL of a 1% sodium ethyl xanthate solution in water, 32.5 of diesel, and 56 μL of pine oil/MIBC (frother). Examples 12-16 for Ore 3 used a collector composition containing 600 g of lime, the listed amount of the collector agent in Table IV, and 56 μL of pine oil/MIBC (frother).

Mining operations will often alter protocols to incorporate collectors that are able to increase the percent recovery of desired metals by as little as 1-2 wt. %, as such an increase translates to a significant overall increase in yield of desirable metals when conducted on a large scale. As shown in Table II, and unexpectedly, Example 2 had a percent recovery of molybdenum of over 93 wt. %, a 1 wt. % increase over the mine standard in Example 1, as well as significant increases over the collectors employed in Examples 3-6. Further, the percent recovery of copper in Example 2 was comparable to the mine standard and the other collectors for Ore 1. In addition, and surprisingly, the percent recovery of iron, which is typically undesirable, was much lower for Example 2 than for the mine standard of Example 1.

Likewise, as shown in Table III, and unexpectedly, using dodecylmethyl sulfide as the collector agent (Example 8) led to a percent recovery of copper of over 93 wt. % from Ore 2. Also, unexpectedly, Example 8 had a percent recovery of iron of only 20.6 wt. % from Ore 2, less than half of that using the mine standard (Example 7). Moreover, and quite surprisingly, the percent recovery of copper in Example 8 from Ore 2 far exceeded each of the other collectors tested, including Example 10 using ethyl n-octyl sulfide.

As shown in Table IV, Example 12 demonstrated excellent percent recoveries for both copper and molybdenum from Ore 3, particularly molybdenum at 93.4 wt. %. Moreover, Table IV shows that dodecylmethyl sulfide again outperformed ethyl n-octyl sulfide, having a lower percent recovery of the undesirable iron from Ore 3, as well as a much lower percent recovery of iron than the mine standard for Ore 3.

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. A collector composition comprising dodecylmethyl sulfide and water.

Aspect 2. The collector composition of aspect 1, further comprising any suitable pH control agent or any pH control agent disclosed herein, e.g., a carbonate compound, or lime.

Aspect 3. The collector composition of any one of aspects 1-2, further comprising any suitable frothing agent or any frothing agent disclosed herein, e.g., MIBC (methyl isobutyl carbinol), pine oil, NALFLOTE® 9837, Cytec OREPREP® X-133, etc., or any combination thereof.

Aspect 4. A collector composition comprising dodecylmethyl sulfide, a frothing agent, a pH control agent, and water.

Aspect 5. The collector composition of any one of aspects 1-4, wherein the collector composition further comprises any second suitable collector agent or any second collector agent disclosed herein, e.g., a xanthate, a xanthic ester, a thionocarbonate, a dialkyl dithiophosphate, etc., or any combination thereof.

Aspect 6. The collector composition of any one of aspects 1-5, wherein the collector composition comprises dodecylmethyl sulfide and a second collector agent, wherein the weight ratio of dodecylmethyl sulfide to the second collector agent is in a range from about 1:10 to about 10:1, from about 1:5 to about 5:1, from about 1:3 to about 1:1, from about 1:2 to about 2:1, from about 1:1 to about 1:10, from about 10:1 to about 1:1, etc.

Aspect 7. The collector composition of any one of aspects 1-5, wherein the collector composition comprises from about 10 wt. % to about 90 wt. % dodecylmethyl sulfide and from about 10 wt. % to about 90 wt. % of a second collector agent, based on the total weight of collector agents.

Aspect 8. A flotation process for the recovery of a metal from an ore, the process comprising contacting the ore with the collector composition of any one of aspects 1-7.

Aspect 9. The process of aspect 8, wherein the metal comprises a transition metal.

Aspect 10. The process of aspect 8, wherein the metal comprises gold, silver, platinum, copper, nickel, iron, lead, zinc, molybdenum, cobalt, chromium, or combinations thereof.

Aspect 11. The process of aspect 8, wherein the metal comprises copper.

Aspect 12. The process of aspect 8, wherein the metal comprises molybdenum.

Aspect 13. The process of any one of aspects 8-12, wherein the ore comprises a copper-bearing ore.

Aspect 14. The process of any one of aspects 8-13, wherein the ore comprises a molybdenum-bearing ore.

Aspect 15. The process of any one of aspects 8-14, wherein the ore comprises an iron-bearing ore.

Aspect 16. The process of any one of aspects 8-15, wherein the ore comprises chalcopyrite.

Aspect 17. The process of any one of aspects 8-16, wherein the ore comprises chalcocite.

Aspect 18. The process of any one of aspects 8-17, wherein the ore comprises pyrite.

Aspect 19. The process of any one of aspects 8-18, wherein the collector composition (excluding the weight of water) and the ore are contacted at a weight ratio in a range from about 1 g of collector composition per ton of ore to about 5 kg of collector composition per ton of ore.

Aspect 20. The process of any one of aspects 8-19, wherein the collector agents (e.g., dodecylmethyl sulfide, dodecylmethyl sulfide and a second collector, etc.) of the collection composition are contacted with the ore at a weight ratio in a range from about 1 g of collector agents per ton of ore to about 1 kg of collector agents per ton of ore.

Aspect 21. The process of any one of aspects 8-20, wherein the percent recovery of copper is at least about 70 wt. %, at least about 80 wt. %, at least about 85 wt. %, at least about 90 wt. %, or at least about 92 wt. %.

Aspect 22. The process of any one of aspects 8-21, wherein the percent recovery of molybdenum is at least about 60 wt. %, at least about 80 wt. %, at least about 85 wt. %, at least about 90 wt. %, or at least about 92 wt. %.

Aspect 23. The process of any one of aspects 8-22, wherein the percent recovery of iron is less than about 40 wt. %, less than about 30 wt. %, less than about 25 wt. %, less than about 20 wt. wt. %, less than about 15 wt. %, or less than about 10 wt. %.

Aspect 24. The process of any one of aspects 8-23, wherein the percent recovery of copper is greater than a mine standard, or within about 5 wt. %, or within about 2 wt. %, of a mine standard, under the same flotation conditions.

Aspect 25. The process of any one of aspects 8-24, wherein the percent recovery of molybdenum is greater than a mine standard, or within about 5 wt. %, or within about 2 wt. %, of a mine standard, under the same flotation conditions.

Aspect 26. The process of any one of aspects 8-25, wherein the percent recovery of iron is less than a mine standard (e.g., by at least about 30 wt. %, by at least about 25 wt. %, by at least about 20 wt. %, by at least about 10 wt. %, by at least about 5 wt. %, etc.), under the same flotation conditions.

Aspect 27. The process of any one of aspects 8-26, wherein the percent recovery of copper is greater than the percent recovery of copper using a collector composition comprising ethyl n-octyl sulfide (e.g., by at least about 15 wt. %, by at least about 10 wt. %, by at least about 5 wt. %, by at least about 3 wt. %, etc.), or within about 5 wt. %, or within about 2 wt. %, of the percent recovery of copper using a collector composition comprising ethyl n-octyl sulfide, under the same flotation conditions.

Aspect 28. The process of any one of aspects 8-27, wherein the percent recovery of molybdenum is greater than the percent recovery of molybdenum using a collector composition comprising ethyl n-octyl sulfide (e.g., by at least about 3 wt. %, by at least about 2 wt. %, by at least about 1 wt. %, etc.), or within about 5 wt. %, or within about 2 wt. %, of the percent recovery of molybdenum using a collector composition comprising ethyl n-octyl sulfide, under the same flotation conditions.

Aspect 29. The process of any one of aspects 8-28, wherein the percent recovery of iron is less than the percent recovery of iron using a collector composition comprising ethyl n-octyl sulfide (e.g., by at least about 5 wt. %, by at least about 3 wt. %, by at least about 2 wt. %, etc.), or within about 5 wt. %, or within about 2 wt. %, of the percent recovery of iron using a collector composition comprising ethyl n-octyl sulfide, under the same flotation conditions.

We claim:

1. A flotation process for the recovery of a metal from an ore, the process comprising:
contacting the ore with a collector composition, wherein the collector composition comprises dodecylmethyl sulfide and water.

2. The process of claim 1, wherein the collector composition further comprises a pH control agent.

3. The process of claim 1, wherein the collector composition further comprises a frothing agent.

4. The process of claim 1, wherein:
the collector composition further comprises a pH control agent and a frothing agent; and
the collector composition comprises less than 0.1 wt. % dodecylmethyl sulfide, excluding the weight of water.

5. The process of claim 4, wherein the collector composition and the ore are contacted at an amount of the collector composition, excluding water, per ton of ore in a range from about 1 g to about 5 kg.

6. The process of claim 1, wherein the collector composition further comprises a second mining chemical collector agent.

7. The process of claim 6, wherein the second mining chemical collector agent comprises a xanthate, a xanthic ester, a thionocarbonate, a dialkyl dithiophosphate, or any combination thereof.

8. The process of claim 1, wherein the metal comprises gold, silver, platinum, copper, nickel, iron, lead, zinc, molybdenum, cobalt, chromium, or combinations thereof.

9. The process of claim 1, wherein the collector composition further comprises a pH control agent and a frothing agent.

10. The process of claim 9, wherein the metal comprises copper, and a percent recovery of copper from the ore is at least about 85 wt. %.

11. The process of claim 9, wherein the metal comprises molybdenum, and a percent recovery of molybdenum from the ore is at least about 60 wt. %.

12. The process of claim 9, wherein the metal comprises iron, and a percent recovery of iron from the ore is less than about 25 wt. %.

13. The process of claim 9, wherein the ore comprises a copper-bearing ore and/or a molybdenum-bearing ore.

14. The process of claim 9, wherein the ore comprises chalcopyrite and/or chalcocite.

15. The process of claim 9, wherein the process is characterized by a percent recovery of copper from the ore that is greater than or within about 5 wt. % of a mine standard for the ore, under the same flotation conditions.

16. The process of claim 15, wherein the percent recovery of copper from the ore is at least about 85 wt. %.

17. The process of claim 9, wherein the process is characterized by a percent recovery of iron from the ore that is less than that of a mine standard for the ore, under the same flotation conditions.

18. The process of claim 9, wherein the process is characterized by:
a percent recovery of copper from the ore that is greater than or within about 5 wt. % of a mine standard for the ore, under the same flotation conditions;
a percent recovery of molybdenum from the ore that is greater than or within about 5 wt. % of a mine standard for the ore, under the same flotation conditions;
a percent recovery of iron from the ore that is less than that of a mine standard for the ore, under the same flotation conditions; or
any combination thereof.

19. The process of claim 9, wherein:
a percent recovery of copper from the ore is greater than or within about 5 wt. % of a percent recovery using ethyl n-octyl sulfide instead of dodecylmethyl sulfide, under the same flotation conditions; and
a percent recovery of iron from the ore is less than or within about 5 wt. % of a percent recovery using ethyl n-octyl sulfide instead of dodecylmethyl sulfide, under the same flotation conditions.

20. The process of claim 9, wherein the metal comprises copper, and a percent recovery of copper from the ore is at least about 90 wt. %.
